(19) United States
(12) Patent Application Publication
(10) Pub. No.: US 2013/0100041 A1
(43) Pub. Date: Apr. 25, 2013

(54) SYSTEM FOR A SINGLE-LAYER SENSOR HAVING REDUCED NUMBER OF INTERCONNECT PADS FOR THE INTERCONNECT PERIPHERY OF THE SENSOR PANEL

(71) Applicants: Mykola Golovchenko, Cupertino, CA (US); Stanislas Pereverzev, Cupertino, CA (US); William Stacy, San Jose, CA (US)

(72) Inventors: Mykola Golovchenko, Cupertino, CA (US); Stanislas Pereverzev, Cupertino, CA (US); William Stacy, San Jose, CA (US)

(73) Assignee: TOUCH TURNS LLC, Santa Clara, CA (US)

(21) Appl. No.: 13/279,139

(22) Filed: Oct. 21, 2011

(51) Int. Cl. G06F 3/041

(52) U.S. Cl. 345/173; 178/18.03

(57) ABSTRACT

The structure disclosed reduces the number of bonding pads and interconnect traces in the opaque portion of a single-layer touch panel. By sharing and multiplexing the bonding pads in the opaque portion of panel, half as many pads are needed to provide the interconnection bases for the traces in the opaque portion of the panel that extend to the control electronics subsystem. Further, by connecting the ground plane structures that are adjacent to each TCO column electrode, all ground planes are made part of a common ground-plane electrode. That single common ground-plane electrode can be connected to the appropriate trace and control electronic subsystem using a single pad, rather than several individual ground-plane pads.

### TECHNICAL FIELD

The present invention relates to a structure and method for connecting touch-panel sensor electrodes to related electronic control subsystems for use in devices featuring touch-screen control.

### BACKGROUND OF THE INVENTION

Many of today's electronic devices, portable devices in particular, feature touch-panel control where a user touches a particular area of a glass screen, or an icon displayed below such a screen, and a subsystem detects that touch and performs a related control function. Touch-panel equipped glass screens are an alternative, for example, to having push-button or keyboard type input devices. In addition to sensing the location of a finger touch, such touch-panel screen controls can also be used to sense motion of the finger touch from one point to another and can respond by, for example, moving the position of an image, drawing a line segment, or increasing or decreasing the magnification of an image. These touch-panels and their control functions are well known in the art.

There are a variety of technologies used in touch-panel equipped systems to determine the position, relative to the screen, of the finger touch. One of the more current and popular technologies uses a mutual-capacitance sensing approach. For mutual-capacitance sensing, using a variety of materials and methods, an array of transparent sensor electrodes are placed onto a transparent glass screen comprising so-called transmitter and receiver electrodes in close proximity to one another. A voltage is applied to the transmitter electrode and a current related to mutual capacitance is detected at the receiver electrode and integrated to find the charge which is directly proportional to mutual capacitance. The transmitter and receiver electrodes must remain isolated from one another, that is, the impedance measured between any two electrodes must be very high. The presence of a finger touch will lower the mutual capacitance by adding a capacitive coupling to ground and its detection in the matrix of transmitter and receiver electrodes indicates where on the glass panel the lowered mutual capacitance has occurred. This is prior art and well known to someone practiced in the art.

Some prior art touch sensing systems use multiple glass plates which enables keeping receiver and transmitter electrodes on separate planes and electrically isolated. But today's handheld devices are particularly sensitive to cost, weight and thickness. For all of these reasons, there is most interest in single-glass-plate touch-sensing systems. Ultimately, a single-glass-plate system requires that the sensor electrodes must be routed to a touch controller subsystem and this involves attaching and routing each electrode in such a way that they remain isolated from one another (e.g. a cross-over connection).

It is common in single-layer sensors to route electrodes to a peripheral area where they are connected to interconnect traces that provide I/O between the sensor panel and control electronics. The bond pads in the peripheral area to which these electrodes are attached are understandably located in a small area which must accommodate the bonds in such a way so they remain isolated from one another. That puts constraints on how small the sensor panel and, in particular, the peripheral area can be made. That, in turn, limits the size reduction for single-layer sensors.

Therefore, a way of accommodating the electrodes and bonds that can permit using a smaller peripheral area and electrode patterns that can reduce the area of the transparent portion of the single panel could lessen the size constraints in sensor-panel dimensions that currently limit sensor panel size reduction.

### BRIEF SUMMARY OF THE INVENTION

It is, therefore, an object of the present invention to provide a system for reducing the number of bonding pads required to interconnect the transparent electrodes to control electronics so as to minimize the area needed in the opaque peripheral portion of the sensor panel. It is also an object of the present invention to ensure that the system for reducing the number of pads will work with any current prior-art transparent electrode configurations.

### BRIEF DESCRIPTIONS OF THE DRAWINGS

FIG. 1 depicts a typical, prior art, approach to implementing touch-control input to an electronic system. As shown, the touch-control system comprises three structures and functions: the touch-screen sensor (101) which functions to determine where a finger has touched the screen by measuring changes in mutual capacitance between transparent conducting transmitter and receiver electrodes; the touch controller (102) which sources voltage to the individual transmitter electrodes and measures the mutual capacitance at the receiver electrodes; and the host controller (103) which uses the touch controller information to determine where a user has touched the screen and what actions are to follow.

FIG. 2 depicts a typical, prior art, touch-sensing node comprising a transmitter electrode (201) and its parasitic capacitance to the substrate ground plane (203); and a receiver electrode (202) and its parasitic capacitance to the substrate ground plane (204); and the mutual capacitance that exists between them (205). A voltage is sourced at point 206 of the transmitter electrode, and the current related to mutual capacitance is measured at point 207 on the receiver electrode.

FIG. 3 depicts a sensor panel (301) divided into an array of X (column) and Y (row) locations. On the transparent portion of the panel, the transparent electrodes, fabricated using transparent conducting oxides or TCOs, are arranged as shown with the transparent portion divided horizontally into columns located along the X axis and vertical positions along the Y axis. A finger touching the panel in the upper left hand portion of the sensor panel would, therefore, show a change in mutual capacitance between the left-most X column electrode and the top-left-most Y row electrode. The transparent electrodes are routed to control electronics by traces located in the opaque portion of the sensor panel 303. A subset of the X and Y electrodes (shown in the dotted lines, 302) will be used in some subsequent figures.

FIG. 4 depicts the subset of electrodes from the previous figure. It represents portions of two X columns and five Y positions. The X column electrodes are 401 and 404. The Y row electrodes adjacent to 401 are shown as 402 and represent Y₁-Y₅. Two ground plane electrodes, 403 and 406 are also shown. Above the electrodes are the 13 different bonding pads (bonds) that connect the transparent electrodes to the traces that connect them to the control electronics. Those horizontally depicted traces and bonds would all be located in the small opaque area (303) of the previous figure. Note that this typical example of a single-panel sensor would require 13 bonds and traces to interconnect these two subsets of the panel.

FIG. 5 depicts some TCO electrode pattern variations that would increase mutual capacitance by increasing the surface area of electrodes in proximity, and thereby increasing the sensitivity to a finger's effect on change in mutual capacitance.

FIG. 6 depicts one way (601) of reducing the number of bonds required to interconnect the TCO electrodes to the traces and control electronics. As shown, five bonds used for each of the five Y TCO electrodes are shared with Y electrodes from both subsets. Thus, instead of needing 10 bonds to accommodate those Y electrodes, only five are used. Instead of 12 bonds (not counting the two ground bonds), the bonds have been reduced to just 7. This represents a reduction of 5 bonds. The second object (602) shows a different pattern for the TCO electrodes that rearranges the TCO electrodes connected to the bonds so that they are now distributed along three sides of the two subsets instead of just two sides. This could allow for more flexible configuration of the transparent portion of the sensor panel. This drawing shows an example of how the bond-reduction invention accommodates different prior-art electrode configurations. In this example, there are two different configurations, but it is meant to be exemplary and should not be seen as limiting the invention to these two examples.

FIG. 7 shows single ground plane (701) instead of individual ground planes. As a result, instead of having n ground planes for n X electrode columns, one could reduce it to 1 ground plane and G bond. That would reduce the number of bonds by n=X−1, where n is the number of G bonds and X is the number of columns. Thus, as shown in this example, the G bonds are reduced by 3, that is, from four distinct G bonds to just a single G bond (702).

FIG. 8 shows another way to reduce the Y electrodes and required bonds without compromising position accuracy. The overlapping cross points (801), shown, provide six Y positions and 1 X position using 7 bonds as opposed to 18 Y electrodes and 1 X electrode without the inter-digit orientation.

FIG. 9 shows how the X and Y electrodes can be arranged so as to use two peripheral areas instead of one for routing the traces to control electronics. This could decrease the transparent sensor area because there would be fewer TCO electrodes being routed to a single peripheral area.

### DETAILED DESCRIPTION OF THE EMBODIMENTS

The following description covers the structure used for reducing the number of pads (e.g. bonding pads) in the opaque portion of the sensor screen.

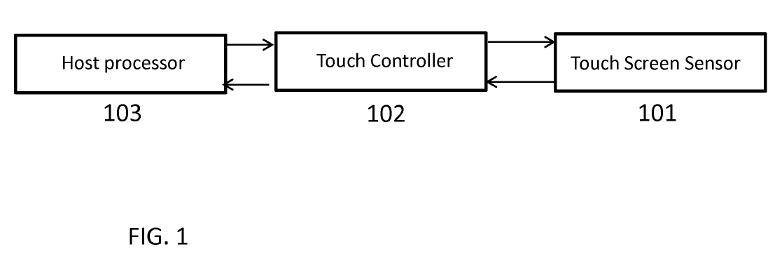

Referring to FIG. 1, the typical touch-screen subsystem comprises a touch-screen sensor (101), a touch controller (102), and a host processor (103). The sensor provides the TCOs in close proximity to one another that permits detecting the presence of a finger tip near one or a plurality of touch sensor nodes. The touch controller sources a voltage to each transmitter electrode and detects the resulting voltage on the receiver electrode. When a finger tip touches the screen above the TCO electrodes, it lowers the mutual capacitance as detected by the sensor and reported by the controller. The controller communicates with the host processor providing it with finger-tip position data, and the host processor uses that data to perform a function or plurality of functions related to the position of the touch, its duration, and/or its path of motion. This is prior art.

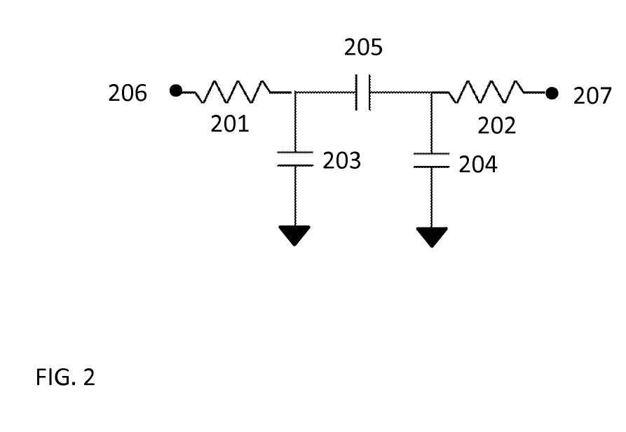

Referring to FIG. 2, the transmitter electrode (201) because of its proximity to the receiver electrode (202) will have a mutual capacitance (205). A voltage sourced at point 206, while charging the parasitic capacitance (203) will produce a current through the receiver electrode (204). That current is integrated to calculate the charge passing through point 207. This charge is directly proportional to the mutual capacitance. When a finger tip touches the glass above a sensor node, it lowers the mutual capacitance by adding a capacitive coupling to ground; and the lower charge that results in the receiving electrode indicates the touch that is affecting one or a plurality of sensor nodes below the finger tip. This is prior art.

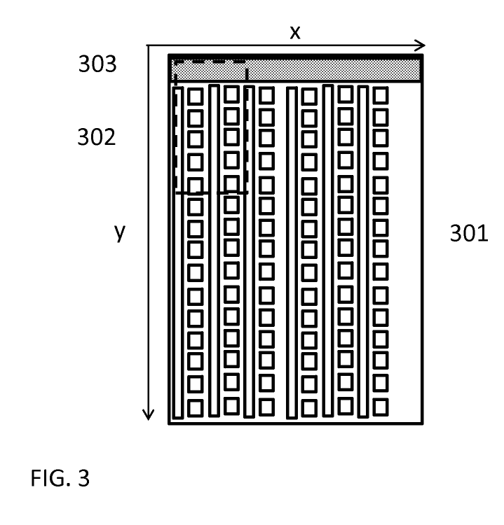

Referring to FIG. 3, a single-panel sensor consists of transparent (TCO) electrodes creating a matrix of position sensitivities along both the X and Y axes. By scanning the X columns and Y positions looking for changes in mutual capacitance, a controller can determine the position of a finger touch, a moving touch, two concurrent touches, their movement relative to one another (e.g. moving together or moving apart) and so on. These positions and motions can then be used to control such things as selecting, scrolling, zooming, and so on.

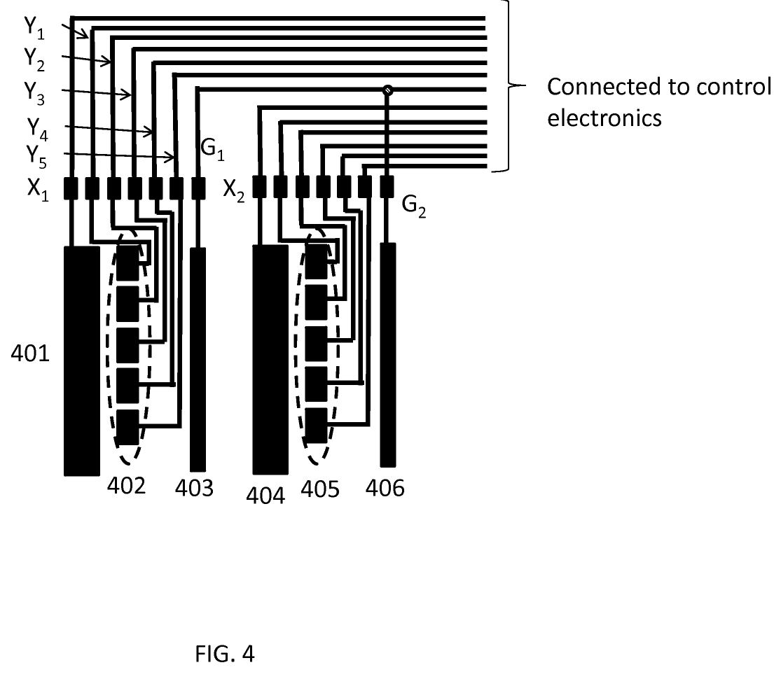

FIG. 4 shows a subset of the electrodes in a single-layer sensor panel matrix. The electrodes include the column electrodes (401 and 404), Y position electrodes (402 and 405), and ground plane electrodes (403 and 406). The conducting bonding pads (bonds) that provide the connections between the TCO electrodes and conducting traces in the opaque periphery of the single-layer panel are shown. Note that in this typical layout, there are 14 bonds used to interconnect the 2 column electrodes, 10 Y electrodes, and 2 ground planes. In this case, there would be 13 separate traces (the G1 and G2 bonds are joined) extending through the opaque area to control electronics. This is prior art.

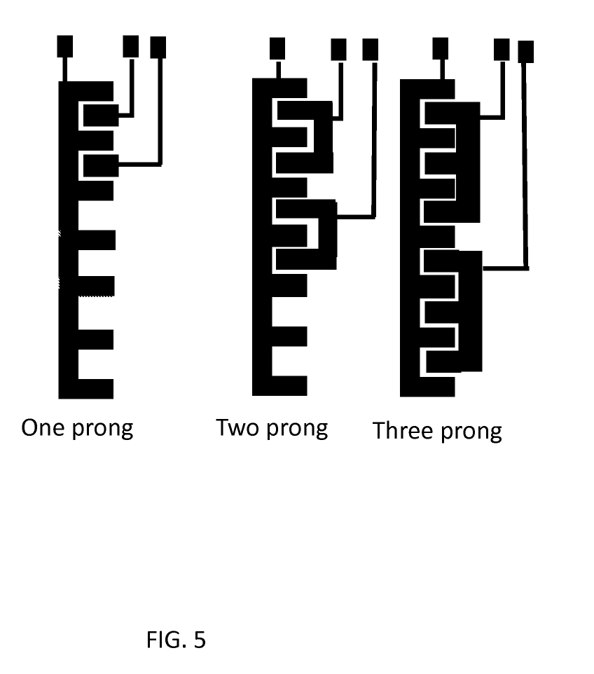

Referring to FIG. 5, this shows some variations in cross point structure and juxtapositions that can increase mutual capacitance (by increasing the area between adjacent electrodes, and, therefore, increased sensitivity to a finger touch's effect on mutual capacitance. These will be referred to as “one prong,” “two prong” and “three prong” structures.

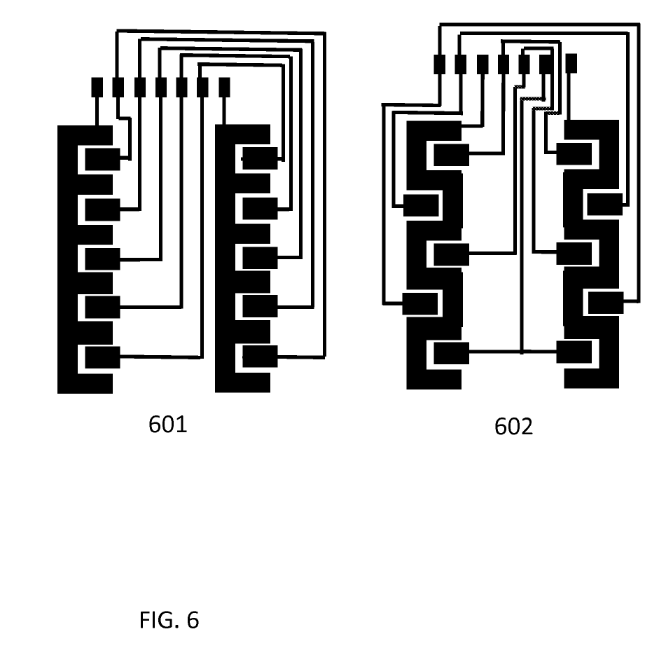

FIG. 6 shows two embodiments of the invention. In the first one, the bonds are shared by the Y electrodes of two adjacent subsets of X and Y electrodes. As such, instead of requiring 10 bonds to interconnect the 5 Y electrodes adjacent to the first X electrode, and 5 Y electrodes adjacent to the second X electrode, only 5 bonds are required to interconnect both. This is not a problem because the X electrodes are scanned sequentially, so the sharing of the bonds among the Y electrodes does not adversely affect position resolution. In the second object (right side of drawing), the electrodes are arranged such that the Y electrodes are adjacent to the X electrode on alternating sides. Hence, instead of the vertical TCO electrodes being routed on two sides as in the left-hand drawing, they are now routed on three sides. That could reduce the amount of area needed to accommodate them because one would need only 4 instead of 5 vertical electrodes between adjoining X electrodes. Note that in both cases, although not shown, the traces that would connect the pads to the control electronics are connected to them using anisotropic conductive film (ACF). This enables the necessary cross-over connections and is prior art.

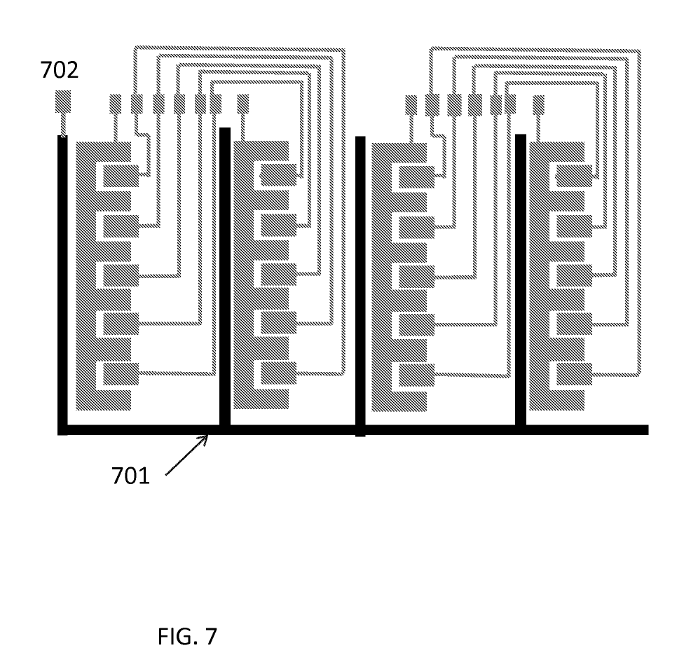

FIG. 7 shows another embodiment of the invention where by using a single ground plane applied to the surface such that portions of it extend adjacent to the X electrodes of adjacent X structures, one can reduce the number of ground planes and ground plane bonds from nₓ (e.g. the same number of X electrodes) to n=1.

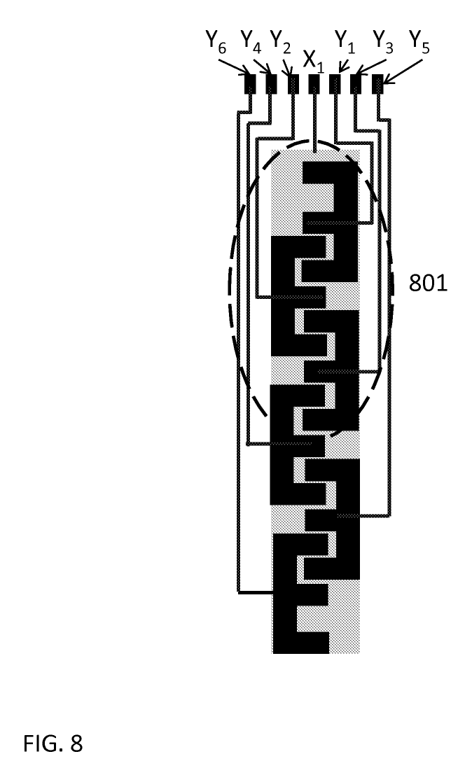

In FIG. 8, by using overlapping Y electrodes such that each one overlaps with a vertically adjacent Y electrode, and using the three-prong structure of FIG. 5, one can reduce the number of Y electrodes required without compromising the position sensitivity of the X, Y electrode subset. For example, in this exemplary figure, the overlapping three-prong structure provides position sensitivity of 18 one prong structures and 18 Y electrodes using just 6, three-prong structures and 6 Y electrodes.

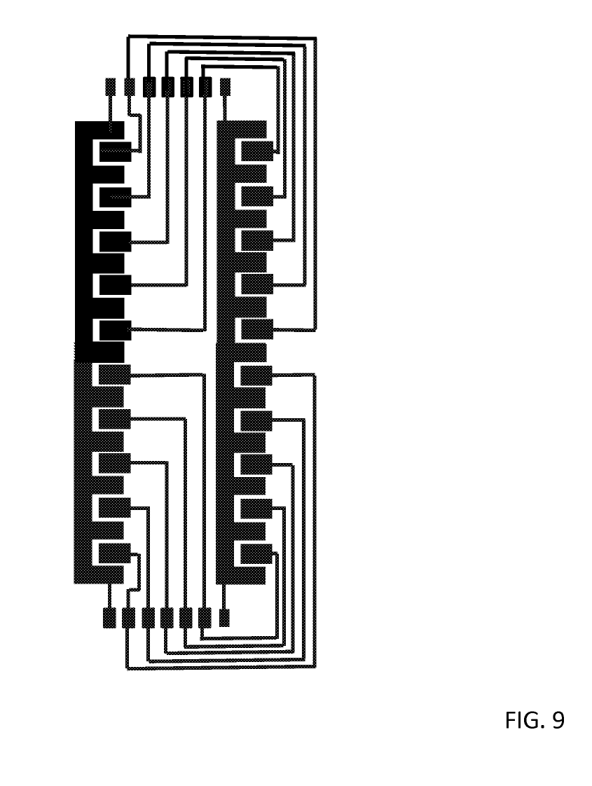

In FIG. 9, by inverting the structure of the X, Y subset shown in FIG. 6 (601) and placing it below the non-inverted structure, one can accommodate the two subsets by routing the vertical TCO electrodes to opposite-side peripheral areas. That would reduce the number of vertical TCO electrodes all being routed to a single peripheral area and, thereby, reduce the amount of space required for that routing by about one-half.

What is claimed is:

1. A system for reducing the number of bonding pads and traces in the opaque portion of a single-layer touch panel comprising:
using half as many pads, to be located in the opaque portion or portions of the panel, as the number of “row” electrodes in two adjacent columns that are to be interconnected to control electronics;
sharing each of said half as many pads by one row electrode in each of two adjacent columns such that each row electrode in each adjacent column is connected to only one shared pad;
connecting said half as many pads to traces extending from the control electronics using anisotropic conductive film to allow cross-over connections;
multiplexing the sensing selection of said half as many pads by using sequential selection of column electrodes.

2. A system for reducing the number of bonding pads and traces in the opaque portion of a single-layer touch panel further comprising:
a ground-plane electrode adjacent to each TCO electrode column;
connecting all ground plane electrodes together through a common interconnect TCO electrode;
connecting said common interconnect TCO electrode to a single bonding pad in the opaque portion of the touch panel;
using said single bonding pad to connect said common interconnect TCO electrode to the appropriate control electronics trace using anisotropic conductive film.
